(19) United States
(12) Patent Application Publication
(10) Pub. No.: US 2025/0308209 A1
(43) Pub. Date: Oct. 2, 2025

(54) CONTENT RECOGNITION METHOD, ELECTRONIC DEVICE, AND STORAGE MEDIUM

(71) Applicant: Beijing Zitiao Network Technology Co., Ltd., Beijing (CN)

(72) Inventor: Fuhang ZONG, Beijing (CN)

(21) Appl. No.: 19/098,787

(22) Filed: Apr. 2, 2025

(30) Foreign Application Priority Data
Apr. 2, 2024 (CN) 202410397335.5

(51) Int. Cl. G06V 10/764

(52) U.S. Cl. CPC G06V 10/764

(57) ABSTRACT

Embodiments of the present disclosure provide a content recognition method and apparatus, an electronic device, and a storage medium. The content recognition method includes: obtaining a first object category of a main object in an image to be recognized based on the main object; obtaining a corresponding target category recognition model based on the first object category, and processing the image to be recognized based on the target category recognition model to obtain a second object category and a corresponding prediction confidence; and obtaining a first recognition result of the image to be recognized based on the second object category and the corresponding prediction confidence, where the first recognition result represents a predicted object category of the main object, and the predicted object category is between the first category hierarchy and the second category hierarchy.

### CROSS-REFERENCE TO RELATED APPLICATION

The present application claims the priority to Chinese Patent Application No. 202410397335.5, filed on Apr. 2, 2024, the entire disclosure of which is incorporated herein by reference as portion of the present application.

### TECHNICAL FIELD

Embodiments of the present disclosure relate to a content recognition method and apparatus, an electronic device, and a storage medium.

### BACKGROUND

At present, content recognition and content classification for media data such as images and videos are widely used in various application scenarios, and the above recognition tasks are usually executed by using a pre-trained classification model. For example, an image to be recognized is input into the classification model to obtain content description of the image that is output by the model.

In order to meet users' query requirements for more specific categories, the classification model is trained by using training samples of more specific categories, so that the classification model can recognize more fine-grained object categories, making the recognition result more precise.

However, in the practical application process, while the classification model pursues a fine-grained classification result, the problem of low classification accuracy of the recognition result is caused.

### SUMMARY

Embodiments of the present disclosure provide a content recognition method and apparatus, an electronic device, and a storage medium, to overcome the problem of low classification accuracy of the recognition result.

The embodiments of the present disclosure provide a content recognition method, including:
obtaining a first object category of a main object in an image to be recognized based on the main object, where the first object category is at a first category hierarchy; obtaining a corresponding target category recognition model based on the first object category, and processing the image to be recognized based on the target category recognition model to obtain a second object category and a corresponding prediction confidence, where the second object category is at a second category hierarchy, and the second category hierarchy is a refined hierarchy of the first category hierarchy; and obtaining a first recognition result of the image to be recognized based on the second object category and the corresponding prediction confidence, where the first recognition result represents a predicted object category of the main object, and the predicted object category is between the first category hierarchy and the second category hierarchy.

The embodiments of the present disclosure further provide a content recognition apparatus, including:
a first recognition module configured to obtain a first object category of a main object in an image to be recognized based on the main object, where the first object category is at a first category hierarchy;
a second recognition module configured to obtain a corresponding target category recognition model based on the first object category, and process the image to be recognized based on the target category recognition model to obtain a second object category and a corresponding prediction confidence, where the second object category is at a second category hierarchy, and the second category hierarchy is a refined hierarchy of the first category hierarchy; and
a processing module configured to obtain a first recognition result of the image to be recognized based on the second object category and the corresponding prediction confidence, where the first recognition result represents a predicted object category of the main object, and the predicted object category is between the first category hierarchy and the second category hierarchy.

The embodiments of the present disclosure further provide an electronic device, including a processor and a memory, where
the memory stores computer-executable instructions; and
the processor executes the computer-executable instructions stored in the memory, to cause the processor to perform the content recognition method according to any one of the embodiments of the present disclosure.

The embodiments of the present disclosure further provide a computer-readable storage medium. The computer-readable storage medium stores computer-executable instructions. When the computer-executable instructions are executed by a processor, the content recognition method according to any one of the embodiments of the present disclosure is implemented.

The embodiments of the present disclosure further provide a computer program product including a computer program. When the computer program is executed by a processor, the content recognition method according to any one of the embodiments of the present disclosure is implemented.

### BRIEF DESCRIPTION OF DRAWINGS

In order to more clearly describe the technical solutions in the embodiments of the present disclosure, the drawings for describing the embodiments will be briefly described below. Apparently, the drawings in the description below show some embodiments of the present disclosure, and those of ordinary skill in the art may still derive other drawings from these drawings without creative efforts.

FIG. 1 is a diagram showing an application scenario of a content recognition method according to an embodiment of the present disclosure;

FIG. 2 is a first schematic flowchart of a content recognition method according to an embodiment of the present disclosure;

FIG. 3 is a flowchart of a specific implementation of step S101 in the embodiment shown in FIG. 2;

FIG. 4 is a schematic diagram of category hierarchies according to an embodiment of the present disclosure;

FIG. 5 is a second schematic flowchart of a content recognition method according to an embodiment of the present disclosure;

FIG. 6 is a schematic diagram of a structure of label tree data according to an embodiment of the present disclosure;

FIG. 7 is a flowchart of a possible implementation of step S204 in the embodiment shown in FIG. 5;

FIG. 8 is a flowchart of a specific implementation of step S2041 in the embodiment shown in FIG. 7;

FIG. 9 is a flowchart of another possible implementation of step S204 in the embodiment shown in FIG. 5;

FIG. 10 is a schematic diagram of a process of verifying an image to be recognized based on a verification model according to an embodiment of the present disclosure;

FIG. 11 is a block diagram of a structure of a content recognition apparatus according to an embodiment of the present disclosure;

FIG. 12 is a schematic diagram of a structure of an electronic device according to an embodiment of the present disclosure; and

FIG. 13 is a schematic diagram of a hardware structure of an electronic device according to an embodiment of the present disclosure.

### DETAILED DESCRIPTION

To make the objectives, technical solutions and advantages of embodiments of the present disclosure clearer, the technical solutions in the embodiments of the present disclosure will be described clearly and completely below with reference to the drawings in the embodiments of the present disclosure. Apparently, the embodiments described are some rather than all of the embodiments of the present disclosure. All the other embodiments obtained by those of ordinary skill in the art based on the embodiments of the present disclosure without any creative effort shall fall within the scope of protection of the present disclosure.

It should be noted that user information (including but not limited to device information, personal information, etc., of a user) and data (including but not limited to data for analysis, stored data, displayed data, etc.) involved in the present disclosure are information and data for which an authorization is obtained from the user or a full authorization is obtained from each party, and the collection, use, and processing of relevant data need to comply with relevant laws, regulations, and standards of relevant countries and regions, for which corresponding operation entries are provided for the user to choose to authorize or deny.

An application scenario of the embodiments of the present disclosure is described below.

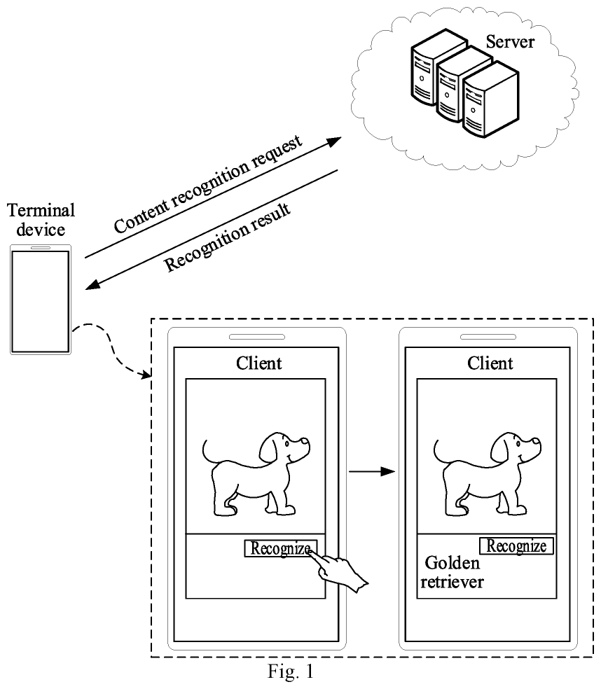

FIG. 1 is a diagram showing an application scenario of a content recognition method according to an embodiment of the present disclosure. The content recognition method according to the embodiment of the present disclosure may be applied to application scenarios such as content search and information recommendation. An execution body of this embodiment may be a terminal device or a server that performs functions of image content recognition and image content classification. Taking the server as an example, after the server receives a content recognition request (the request contains an image to be recognized) sent by the terminal device, the server obtains a name of a main object in the image to be recognized, that is, a recognition result, by performing the method provided in this embodiment, and returns the recognition result to the terminal device side for display. Specifically, referring to FIG. 1, the terminal device loads an image to be recognized including “Dog” at a client, and sends, in response to a trigger operation performed by a user on a trigger control (with a control name being “Recognize”), the image to be recognized to the server side for processing. Then, the server returns text (that is, a recognition result, such as “Golden retriever”) describing the breed name of the “Dog” in the image to be recognized to the client of the terminal device for display, thus completing the image-based content recognition process.

In order to meet users' query requirements for more specific categories in a content recognition function, a recognition model is trained by using training samples of more specific categories, so that the recognition model can recognize more fine-grained object categories, making the recognition result more precise. For example, by using the above recognition model, different categories divided based on dog breeds (Labrador retriever and Bichon Frise) and dog characteristics (elderly dogs and young dogs) can be recognized, instead of just recognizing “Dog” and “Cat”. However, in the practical application process, while the above recognition model pursues a fine-grained classification result, the generalization capability of the model is degraded, thereby affecting accuracy of the recognition result output by the model.

The embodiments of the present disclosure provide a content recognition method, which ensures correctness of the recognition result while implementing content recognition with a finer classification granularity, thus solving the above problems.

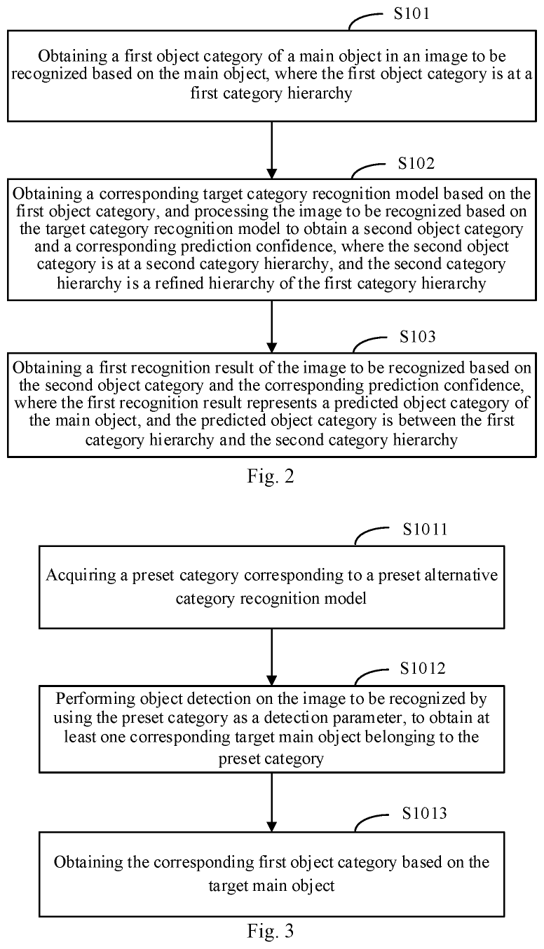

Referring to FIG. 2, FIG. 2 is a first schematic flowchart of a content recognition method according to an embodiment of the present disclosure. The method of this embodiment may be applied to a server. The content recognition method includes the following steps.

Step S101: obtaining a first object category of a main object in an image to be recognized based on the main object, where the first object category is at a first category hierarchy.

For example, referring to the schematic diagram of the application scenario shown in FIG. 1, taking the case where a server is used as an execution body of this method embodiment as an example, the server may receive a recognition request sent by a terminal device to obtain an image to be recognized that corresponds to the recognition request. The image to be recognized may be included in the recognition request to be sent by the terminal device, or may be stored on another third-party storage device or locally on the server. The specific way to obtain the image to be recognized is not specifically limited herein. Then, the server processes the image to be recognized and recognizes a main object in the image to be recognized. An object in the image is a content object, such as a person, an object, or an animal. The main object is a content object that serves as a content subject in the image to be recognized. When a distinct content object is included in the image to be recognized, the content object is the main object. For example, the only person in a single photo is the main object. When a plurality of content objects are included in the image to be recognized, the main object therein may be determined based on factors such as the position of each content object and the image area taken by the content object, as well as factors such as contour sharpness. For example, a content object at a center of the image that takes a larger area is the main object. There may be one or more main objects. In a specific implementation, the image to be recognized is processed by using an image recognition model, and the main object is recognized based on pixel features formed by pixel values of pixels of the image to be recognized.

Further, after the main object is recognized, an object category corresponding to the main object may be obtained by recognizing the type of the main object. For example, recognizing the main object as “Cats”, “Labrador retriever”, or the like is the implementation of the object category. In the present embodiment, the object category obtained by recognizing the main object is a first object category, that is, the first object category is at the first category hierarchy. The category hierarchy is a manner of describing a category refinement (generalization) degree. For example, a lower category hierarchy indicates a higher category generalization degree. For example, “Dogs” is an object category at a low category hierarchy. On the contrary, a higher category hierarchy indicates a higher category refinement degree, such as “Black Labrador retriever”. With reference to the descriptions in the subsequent embodiments, the first category hierarchy in the steps of the present embodiment corresponds to a lower category hierarchy, and the first object category at the first category hierarchy has a higher generalization degree and is a coarse-grained classification result, such as “Dogs” in the above example. Therefore, a specific implementation of obtaining the first object category in the present embodiment may be implemented by processing the image to be recognized using a universal image recognition model (hereinafter referred to as a universal recognition model).

Further, in a possible implementation, as shown in FIG. 3, a specific implementation of step S101 includes:
step S1011: acquiring a preset category corresponding to a preset alternative category recognition model;
step S1012: performing object detection on the image to be recognized by using the preset category as a detection parameter, to obtain at least one corresponding target main object belonging to the preset category; and
step S1013: obtaining the corresponding first object category based on the target main object.

For example, in the steps of the present embodiment, during the process of recognizing the first object category by a pre-trained universal recognition model, several preset categories corresponding to alternative category recognition models are first obtained. For example, an alternative category recognition model M1 corresponding to “Dogs”, an alternative category recognition model M2 corresponding to “Cats”, and an alternative category recognition model M3 corresponding to “Birds” are selected. The server subsequently implements fine-grained recognition of the main object in the image to be recognized by using one of the above three alternative category recognition models. Therefore, in the steps of the present embodiment, for example, M1, M2 and M3 as parameters are input to the universal recognition model to direct the universal recognition model to recognize only objects of preset categories corresponding to M1, M2 and M3, to obtain a target main object in the image to be recognized. Then, after the steps of recall, sequencing, etc. are performed, from one or more recognized target main objects, the one with the highest confidence is determined as an output object, and an object category (when recognizing the target main object, the universal recognition model synchronizes object categories corresponding to exporters) of the output object is determined as the first object category.

In the steps of the present embodiment, control parameters (preset categories) are input to the universal recognition model. Therefore, on one hand, the universal recognition model only recognizes targets of the above preset categories in the running process, so that the recognition calculation amount of the model can be reduced. On the other hand, target main objects output by the universal recognition model only include target main objects of the above preset categories, so that the accuracy of the obtained first object category is improved, and the subsequent problem of incorrect selection of a target category recognition model caused by inaccuracy of the first object category is reduced.

Step S102: obtaining a corresponding target category recognition model based on the first object category, and processing the image to be recognized based on the target category recognition model to obtain a second object category and a corresponding prediction confidence, where the second object category is at a second category hierarchy, and the second category hierarchy is a refined hierarchy of the first category hierarchy.

For example, after the first object category is obtained, based on the first object category, a corresponding matched category recognition model, that is, a target category recognition model, is selected. For example, the first object category may be denoted by a category identifier. When the first object category is #1, it indicates that the corresponding object category is “Dogs”. In this case, the model M1 special for dog image recognition, that is, the target category recognition model, is acquired, and the image to be recognized or a processed image generated based on the image to be recognized (for example, an image generated through cropping processing and down-sampling processing) is processed to generate a second object category and a corresponding prediction confidence. The second object category is at the second category hierarchy, which is a refined hierarchy of the first category hierarchy. That is, the second object category is a refined category of the first object category obtained in the previous step (correspondingly, the first category hierarchy is a generalized hierarchy of the second category hierarchy, the first object category is a generalized category of the second object category, and the two are relative to each other). More specifically, for example, the first object category is “Dogs”, and the second object category obtained based on the capability of the target category recognition model is “Elderly Labrador retriever”.

Based on the above description, the category recognition model may be understood as an image recognition model for processing an image with “specific content”. The image to be recognized is recognized by a target category recognition model matching the first object category, and the fine-grained classification capability of the target category recognition model for “specific content” is fully used to obtain a recognition result with a more refined category, that is, the second object category. In addition, similar to other image recognition models, the category recognition model outputs a prediction confidence, also known as credibility, along with the predicted object category. The greater the prediction confidence, the more credible the predicted result (object category) is considered to be; conversely, the lower the prediction confidence, the less credible the result. For example, the second object category obtained by the server in the present embodiment may be an object category with the greatest prediction confidence that is output by the target category recognition model after recall and sequencing. The above category recognition model is generated through training based on training samples with “specific content”, and the specific training process thereof is not described herein.

Step S103: obtaining a first recognition result of the image to be recognized based on the second object category and the corresponding prediction confidence, where the first recognition result represents a predicted object category of the main object, and the predicted object category is between the first category hierarchy and the second category hierarchy.

For example, after the second object category and the corresponding prediction confidence are obtained, the server further evaluates the credibility of the predicted second object category based on the prediction confidence. When the prediction confidence is greater, it indicates that the second object category predicted by the target category recognition model is credible, that is, the target category recognition model selected based on the above step has a capability of accurately recognizing a fine-grained object category. In this case, the second object category may be directly used as the finally output first recognition result to achieve the purpose of classification accuracy. When the prediction confidence is lower, it indicates that the second object category predicted by the target category recognition model is not credible. In this case, an object category that is more generalized than the second object category may be acquired as a predicted object category, and then the first recognition result may be generated.

For example, in response to the second object category being “Elderly Labrador retriever” and the corresponding prediction confidence thereof being less than the confidence threshold, the second object category is generalized to obtain a predicted object category of “Labrador retriever”, and the predicted object category is taken as the first recognition result. The category hierarchy of the predicted object category is a generalized hierarchy of the second category hierarchy corresponding to the second object category.

Further, in a possible implementation, a pre-trained text generalization model may be used to process the second object category to obtain a corresponding predicted object category. That is, by using the above text generalization model, at least one limiting feature in description text corresponding to the second object category may be removed. For example, “Elderly” is removed from “Elderly Labrador retriever” to generate “Labrador retriever”, so as to implement category generalization. A specific implementation of the text generalization model is related to a training manner thereof, and details are not described herein.

Certainly, in another possible implementation, the process of generalizing the second object category to obtain a predicted object category may alternatively be implemented based on preset data that can describe a logical relationship between different category hierarchies, such as label tree data. A specific implementation is described in detail in the following embodiments, and may be specifically set as required.

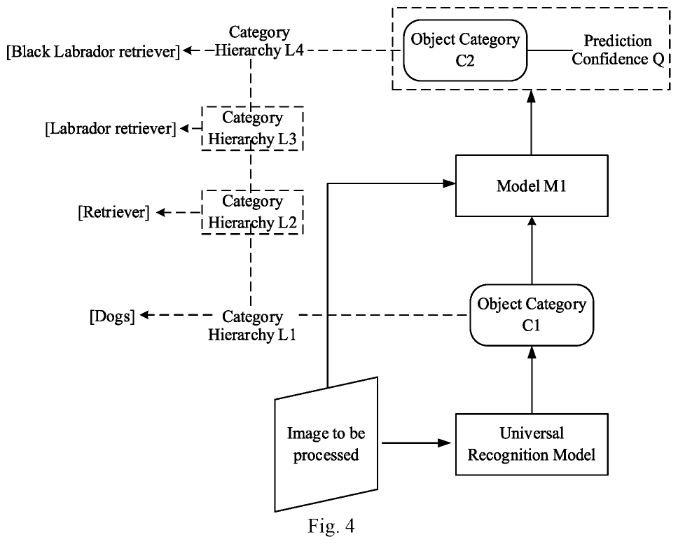

FIG. 4 is a schematic diagram of category hierarchies according to an embodiment of the present disclosure. The above process is further described below with reference to FIG. 4. For example, as shown in FIG. 4, an image to be recognized is first processed by using a universal recognition model to obtain a first object category (shown as an object category C1 in the figure), with specific content being, for example, “Dogs”, and the first object category is at a first category hierarchy (shown as a category hierarchy L1 in the figure). Then a corresponding target category recognition model (shown as a model M1 in the figure) is determined through the first object category, and the image to be processed is processed by using the target category recognition model to obtain a second object category (shown as an object category C2 in the figure) and a corresponding prediction confidence Q. Specific content of the second object category is, for example, “Black Labrador retriever”, and the second object category is at a second category hierarchy (shown as a category hierarchy L4 in the figure). As shown in the figure, the category hierarchy L4 is a refined hierarchy of the category hierarchy L1, corresponding to a more refined category. Based on a hierarchy relationship recorded in the preset label tree data, for example, a category hierarchy L2 corresponding to a category object C3, with specific content being, for example, “Retriever”, and a category hierarchy L3 corresponding to a category object C4, with specific content being, for example, “Labrador retriever”, are further included between the category hierarchy L1 and the category hierarchy L4. Then, based on a specific numerical value of the prediction confidence Q, one of the category objects C1, C3, and C4 is selected as a predicted object category, thereby obtaining the first recognition result.

In the present embodiment, a first object category of a main object in an image to be recognized is obtained based on the main object, where the first object category is at a first category hierarchy; a corresponding target category recognition model is obtained based on the first object category, and the image to be recognized is processed based on the target category recognition model to obtain a second object category and a corresponding prediction confidence, where the second object category is at a second category hierarchy, and the second category hierarchy is a refined hierarchy of the first category hierarchy; and a first recognition result of the image to be recognized is obtained based on the second object category and the corresponding prediction confidence, where the first recognition result represents a predicted object category of the main object, and the predicted object category is between the first category hierarchy and the second category hierarchy. After coarse-grained classification is performed on the image to be recognized, the corresponding target category recognition model is selected to perform fine-grained classification on the main object in the object to be recognized, to obtain the second object category and the corresponding prediction confidence; and then the second object category is corrected based on the prediction confidence, to obtain the first recognition result that balances classification accuracy and classification correctness, thereby ensuring accuracy of the recognition result while maintaining a fine classification granularity of the recognition result.

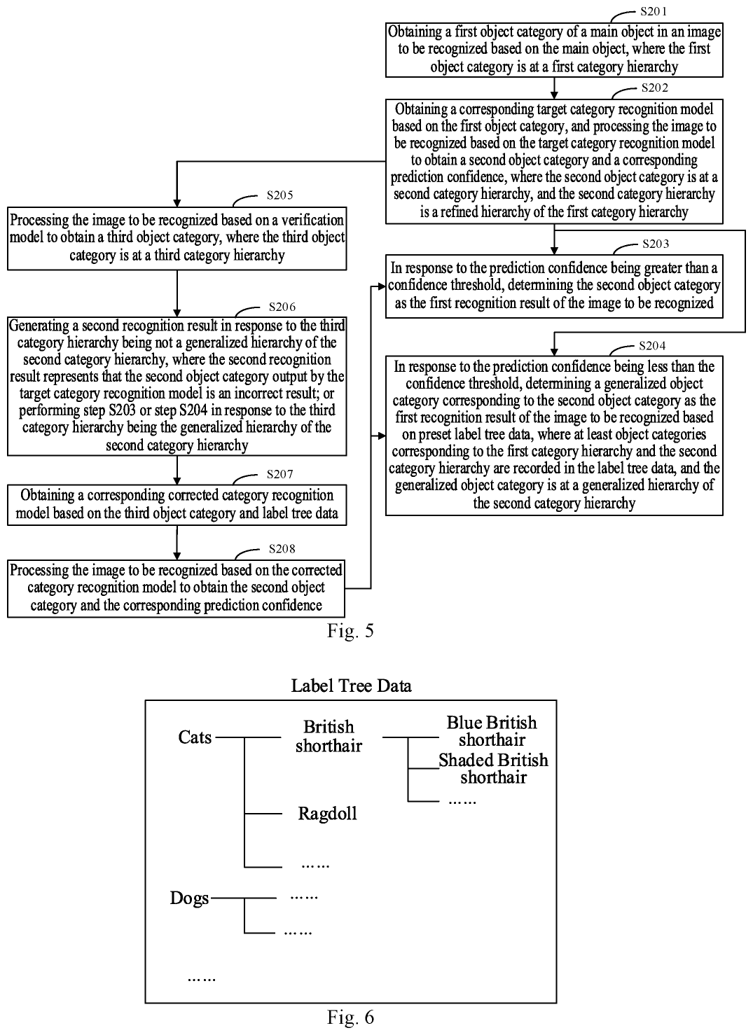

Referring to FIG. 5, FIG. 5 is a second schematic flowchart of a content recognition method according to an embodiment of the present disclosure. On the basis of the embodiment shown in FIG. 2, in the present embodiment, step S102 is further described in more detail, and a step of rechecking the second object category is added. The content recognition method includes the following steps.
Step S201: obtaining a first object category of a main object in an image to be recognized based on the main object, where the first object category is at a first category hierarchy.
Step S202: obtaining a corresponding target category recognition model based on the first object category, and processing the image to be recognized based on the target category recognition model to obtain a second object category and a corresponding prediction confidence, where the second object category is at a second category hierarchy, and the second category hierarchy is a refined hierarchy of the first category hierarchy.
Step S203: in response to the prediction confidence being greater than a confidence threshold, determining the second object category as the first recognition result of the image to be recognized.
Step S204: in response to the prediction confidence being less than the confidence threshold, determining a generalized object category corresponding to the second object category as the first recognition result of the image to be recognized based on preset label tree data, where at least object categories corresponding to the first category hierarchy and the second category hierarchy are recorded in the label tree data, and the generalized object category is at a generalized hierarchy of the second category hierarchy.

For example, referring to the related description in the embodiment shown in FIG. 2, in response to the prediction confidence being greater than or equal to the confidence threshold, the second object category may be directly determined as the first recognition result of the image to be recognized, and this case is not repeated. In response to the prediction confidence being less than or equal to the confidence threshold, a generalized object category corresponding to the second object category is obtained based on the preset label tree data, and then the generalized object category is taken as the first recognition result of the image to be recognized. Specifically, the label tree data is data used to record the logical relationship between category hierarchies, and at least object categories corresponding to the first category hierarchy and the second category hierarchy are recorded in the label tree data.

FIG. 6 is a schematic diagram of a structure of label tree data according to an embodiment of the present disclosure. Referring to FIG. 6, under a first category hierarchy, there are relatively coarse-grained category names such as “Cats” and “Dogs”, and a specific implementation of object categories under the first category hierarchy may be set as required, and may alternatively be, for example, “Terrestrial creatures” and “Aquatic creatures”. Further, taking “Cats” as an example, under its refined hierarchy, that is, the second category hierarchy, corresponding object categories include “British shorthair”, “Ragdoll”, etc., and object categories under a subordinate refined hierarchy of “British shorthair” include “Blue British shorthair”, “Shaded British shorthair”, etc. Based on the above data structure, the label tree data records the logical relationship between different category hierarchies under the same root category. At least object categories corresponding to the first category hierarchy and the second category hierarchy are recorded in the label tree data, and thus a generalized object category corresponding to the second object category may be taken as a first recognition result based on the label tree data.

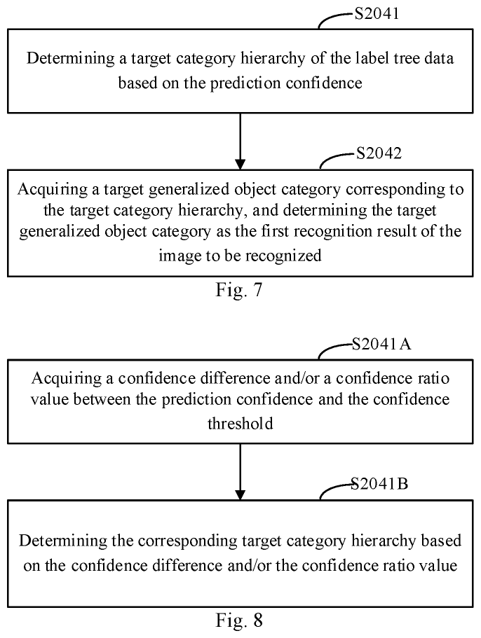

Further, in a possible implementation, as shown in FIG. 7, step S204 includes the following implementation steps:
step S2041: determining a target category hierarchy of the label tree data based on the prediction confidence; and
step S2042: acquiring a target generalized object category corresponding to the target category hierarchy, and determining the target generalized object category as the first recognition result of the image to be recognized.

For example, in the steps of the present embodiment, the server first determines, based on the prediction confidence obtained in the previous step, a target category hierarchy matching the prediction confidence from the label tree structure described by the label tree data. Specifically, for example, a greater prediction confidence (in the case of being less than the confidence threshold) indicates a higher corresponding target category hierarchy, and means a finer classification granularity and more accurate classification of the corresponding target generalized object category. On the contrary, a lower prediction confidence indicates a lower corresponding target category hierarchy, and means a coarser classification granularity and more general classification of the corresponding target generalized object category, but greater correctness of the corresponding target generalized object category. For example, there may be a preset mapping relationship between the prediction confidence and the target category hierarchy, and thus the target category hierarchy is determined based on the mapping relationship.

In another possible implementation, as shown in FIG. 8, an implementation of step S2041 includes:
step S2041A: acquiring a confidence difference and/or a confidence ratio value between the prediction confidence and the confidence threshold; and
step S2041B: determining the corresponding target category hierarchy based on the confidence difference and/or the confidence ratio value.

For example, after obtaining the prediction confidence, the server determines a distance relationship between the prediction confidence and the confidence threshold based on the confidence difference and/or the confidence ratio value therebetween, and then determines the corresponding target category hierarchy based on the distance relationship. In the steps of the present embodiment, when the target category hierarchy is mapped based on the prediction confidence, further reference is made to the factor of the confidence threshold, to avoid interference caused by different confidence thresholds corresponding to prediction confidences output by different target category recognition models, thereby further improving accuracy of the determined target category hierarchy, and further improving accuracy of the recognition result while ensuring correctness of the recognition result.

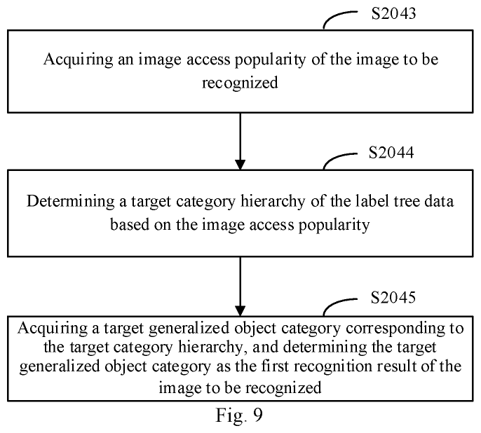

In another possible implementation, as shown in FIG. 9, step S204 includes the following implementation steps:
step S2043: acquiring an image access popularity of the image to be recognized;
step S2044: determining a target category hierarchy of the label tree data based on the image access popularity; and
step S2045: acquiring a target generalized object category corresponding to the target category hierarchy, and determining the target generalized object category as the first recognition result of the image to be recognized.

For example, in another possible implementation, for the image to be recognized, the target category hierarchy is dynamically determined based on the image access popularity of the image to be recognized. The image access popularity of the image to be recognized means a frequency at which the image to be recognized is accessed. Specifically, for example, in response to the image to be recognized being a target object with a high popularity, that is, a high access frequency, a higher (refined) category hierarchy is determined as a target category hierarchy; otherwise, a lower (generalized) category hierarchy is set therefor as a target category hierarchy.

This is because the label tree data is constructed based on the image access popularity. For example, categories with a high access popularity such as “Cats” and “Dogs” correspond to more sample image groups with more refined classification. Therefore, label tree data generated based on the sample data has a better description capability corresponding to an image with such a high access popularity, and can accurately describe a category name of an image body in the image at a more fine-grained and refined classification hierarchy. On the contrary, categories with a low access popularity such as “Microbes” correspond to a small quantity of more coarsely classified sample image groups in sample data for constructing the label tree data. Consequently, the label tree data cannot describe very fine-grained classification names. Therefore, when the image to be recognized is processed, based on the image access popularity of the image to be recognized, a higher target category hierarchy (refined hierarchy) is set for the image to be recognized with a high image access popularity, thereby improving recognition accuracy and implementing more accurate content search. When an image to be recognized with a low image access popularity is processed, a lower target category hierarchy (generalized hierarchy) is set to ensure correctness of the recognition result.

Optionally, in another aspect, after step S202, the method further includes:
step S205: processing the image to be recognized based on a verification model to obtain a third object category, where the third object category is at a third category hierarchy; and
step S206: generating a second recognition result in response to the third category hierarchy being not a generalized hierarchy of the second category hierarchy, where the second recognition result represents that the second object category output by the target category recognition model is an incorrect result; or performing step S203 or step S204 in response to the third category hierarchy being the generalized hierarchy of the second category hierarchy.

For example, in another aspect, in order to further increase the probability of correctness of the recognition result, after step S202 is completed to obtain the second object category, the second object category is further rechecked by using a preset verification model. Specifically, the image to be recognized is first processed by the verification model. The verification model may be understood as an image recognition model with a lower classification granularity. More specifically, for example, the recognition result (such as the first object category) output by a universal recognition model is at the lower category hierarchy L1, and a recognition result (such as the second object category) output by a category recognition model is at the higher category hierarchy L3, whereas a recognition result (such as the third object category) output by the verification model is at the category hierarchy L2 therebetween, namely, the above third category hierarchy. Then, the third category hierarchy and the second category hierarchy are checked based on the label tree data, and in response to that the third category hierarchy is a generalized hierarchy of the second category hierarchy, that is, the third object category and the second object category are on the same category branch path, the recognition result of the second object category is correct with a high probability. In this case, subsequent step S203 or S204 may be continued. On the contrary, in response to that the third category hierarchy is not the generalized hierarchy of the second category hierarchy, that is, the third object category and the second object category are not on the same category branch path, it indicates incorrect recognition of either of the second object category and the third object category. In addition, considering that the verification model has corresponding lower classification accuracy and higher generalization capability, the third object category output by the verification model has higher credibility. Therefore, in this case, the second recognition result is generated, and the second recognition result represents that the second object category output by the target category recognition model is an incorrect result. Then, the server may further correct the above process based on the second recognition result until a correct result, namely, the first recognition result, is obtained.

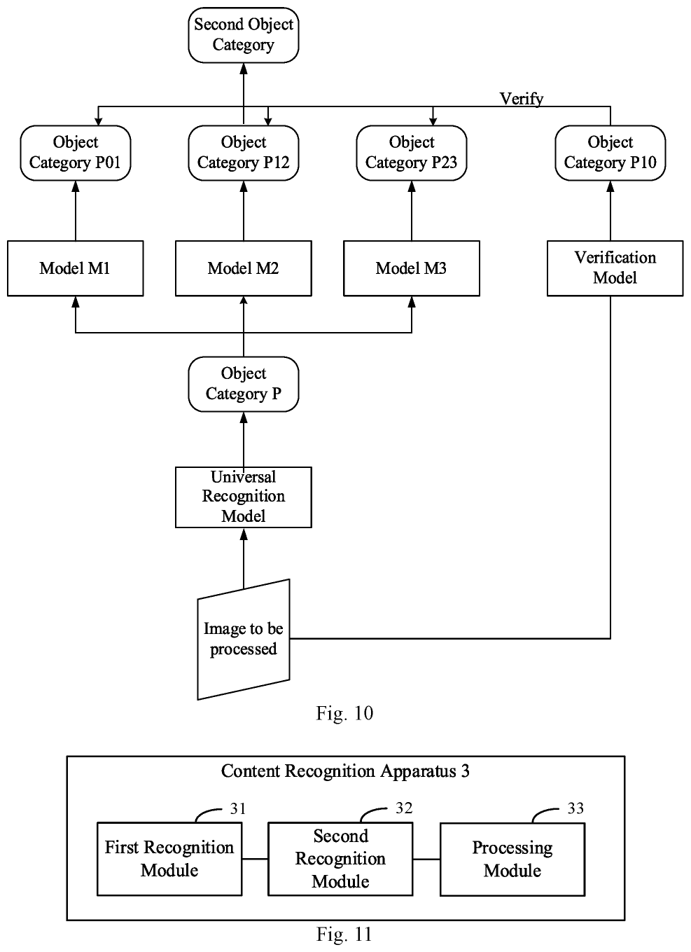

FIG. 10 is a schematic diagram of a process of verifying an image to be recognized based on a verification model according to an embodiment of the present disclosure. As shown in FIG. 10, for example, the image to be recognized is first processed by using a universal recognition model to determine an object category P, which represents, for example, “Animals”, and then a plurality of target category recognition models, such as a model M1, a model M2, and a model M3 shown in the figure, are determined. For example, the target category recognition models are category recognition models with further refined classification for “Birds”, “Dogs”, and “Cats”. Then, the above models M1, M2, and M3 are used to process the image to be recognized, to obtain their corresponding second object categories, such as an object category P01, an object category P12, and an object category P23 shown in the figure, which respectively denote, for example, “Ostrich”, “Labrador retriever”, and “Orange cat”. In another aspect, the image to be processed is processed by using the verification model to obtain a corresponding third object category, such as P10 shown in the figure, which represents, for example, “Hound”. Then, the above second object category is checked based on the label tree data and the third object category, to determine that the object category P12 (Labrador retriever) belongs to the same category branch path as the object category P10 (hound), that is, the category hierarchy of the object category P10 is the generalized hierarchy of the category hierarchy of the object category P12. Therefore, the object category P12 is taken as the second object category after rechecking to perform subsequent steps.

Further, in another possible implementation, after step S206, the method further includes:
step S207: obtaining a corresponding corrected category recognition model based on the third object category and label tree data; and
step S208: processing the image to be recognized based on the corrected category recognition model to obtain the second object category and the corresponding prediction confidence.

For example, in response to that there is only one second object category that is obtained by the server based on step S202, and a second recognition result (that is, incorrect recognition of a target category recognition model) is obtained after step S206, the target category recognition model may be further replaced based on the third object category. For example, the currently used target category recognition model M1 is replaced with the corrected category recognition model M2 corresponding to the third object category, and the image to be recognized is further processed based on the corrected category recognition model M2 to obtain an updated second object category and corresponding prediction confidence. The execution process thereof is similar to that of step S202. Then, step S203 or step S204 is performed again based on the updated second object category and the corresponding prediction confidence, and the prediction confidence is reused for determining until the first recognition result is obtained.

In the steps of the present embodiment, in response to the second object category output by the target category recognition model being an incorrect result, the currently used target category recognition model is corrected based on the third object category output by the verification model to obtain a corrected category recognition model. This is equivalent to selecting a suitable category recognition model again, thereby correcting the problem of incorrect selection of the target category recognition model caused by inaccurate recognition by the universal recognition model, and improving accuracy of the first recognition result.

In the present embodiment, the implementations of steps S201 and S202 are the same as the implementations of steps S101 and S102 in the embodiment shown in FIG. 2 of the present disclosure, and details are not repeated herein.

Corresponding to the content recognition method in the above embodiments, FIG. 11 is a block diagram of a structure of a content recognition apparatus according to an embodiment of the present disclosure. The method described in the above embodiment may be performed by the content recognition apparatus. The apparatus may be implemented by software and/or hardware and may be integrated into an electronic device with a certain data processing function. The electronic device may include, but is not limited to, a mobile terminal with a big data processing capability, and a fixed terminal with a big data processing capability such as a desktop computer and a supercomputer.

For ease of illustration, only parts related to the embodiment of the present disclosure are shown. Referring to FIG. 11, a content recognition apparatus 3 includes:
a first recognition module 31 configured to obtain a first object category of a main object in an image to be recognized based on the main object, where the first object category is at a first category hierarchy;
a second recognition module 32 configured to obtain a corresponding target category recognition model based on the first object category, and process the image to be recognized based on the target category recognition model to obtain a second object category and a corresponding prediction confidence, where the second object category is at a second category hierarchy, and the second category hierarchy is a refined hierarchy of the first category hierarchy; and
a processing module 33 configured to obtain a first recognition result of the image to be recognized based on the second object category and the corresponding prediction confidence, where the first recognition result represents a predicted object category of the main object, and the predicted object category is between the first category hierarchy and the second category hierarchy.

According to one or more embodiments of the present disclosure, the first recognition module 31 is configured to: acquire a preset category corresponding to a preset alternative category recognition model; perform object detection on the image to be recognized based on the preset category corresponding to the alternative category recognition model, to obtain at least one corresponding target main object belonging to the preset category; and obtain the corresponding first object category based on the target main object.

According to one or more embodiments of the present disclosure, the processing module 33 is configured to: in response to the prediction confidence being greater than a confidence threshold, determine the second object category as the first recognition result of the image to be recognized; or in response to the prediction confidence being less than the confidence threshold, determine a generalized object category corresponding to the second object category as the first recognition result of the image to be recognized based on preset label tree data, where at least object categories corresponding to the first category hierarchy and the second category hierarchy are recorded in the label tree data, and the generalized object category is at a generalized hierarchy of the second category hierarchy.

According to one or more embodiments of the present disclosure, when determining the generalized object category corresponding to the second object category as the first recognition result of the image to be recognized based on the preset label tree data, the processing module 33 is configured to: determine a target category hierarchy of the label tree data based on the prediction confidence; and acquire a target generalized object category corresponding to the target category hierarchy, and determine the target generalized object category as the first recognition result of the image to be recognized.

According to one or more embodiments of the present disclosure, when determining the target category hierarchy of the label tree data based on the prediction confidence, the processing module 33 is configured to: acquire a confidence difference and/or a confidence ratio value between the prediction confidence and the confidence threshold; and determine the corresponding target category hierarchy based on the confidence difference and/or the confidence ratio value.

According to one or more embodiments of the present disclosure, when determining the generalized object category corresponding to the second object category as the first recognition result of the image to be recognized based on the preset label tree data, the processing module 33 is configured to: acquire an image access popularity of the image to be recognized; determine a target category hierarchy of the label tree data based on the image access popularity; and acquire a target generalized object category corresponding to the target category hierarchy, and determine the target generalized object category as the first recognition result of the image to be recognized.

According to one or more embodiments of the present disclosure, after processing the image to be recognized based on the target category recognition model to obtain the second object category and the corresponding prediction confidence, the second recognition module 32 is further configured to: process the image to be recognized based on a verification model to obtain a third object category, where the third object category is at a third category hierarchy; and generate a second recognition result in response to the third category hierarchy being not a generalized hierarchy of the second category hierarchy, where the second recognition result represents that the second object category output by the target category recognition model is an incorrect result.

According to one or more embodiments of the present disclosure, after generating the second recognition result, the second recognition module 32 is further configured to: obtain a corresponding corrected category recognition model based on the third object category and label tree data; and process the image to be recognized based on the corrected category recognition model to obtain the second object category and the corresponding prediction confidence.

The first recognition module 31, the second recognition module 32, and the processing module 33 are connected in sequence. The content recognition apparatus 3 in the present embodiment may perform the technical solutions of the above method embodiments. The implementation principles and technical effects thereof are similar, which are not repeated in the present embodiment.

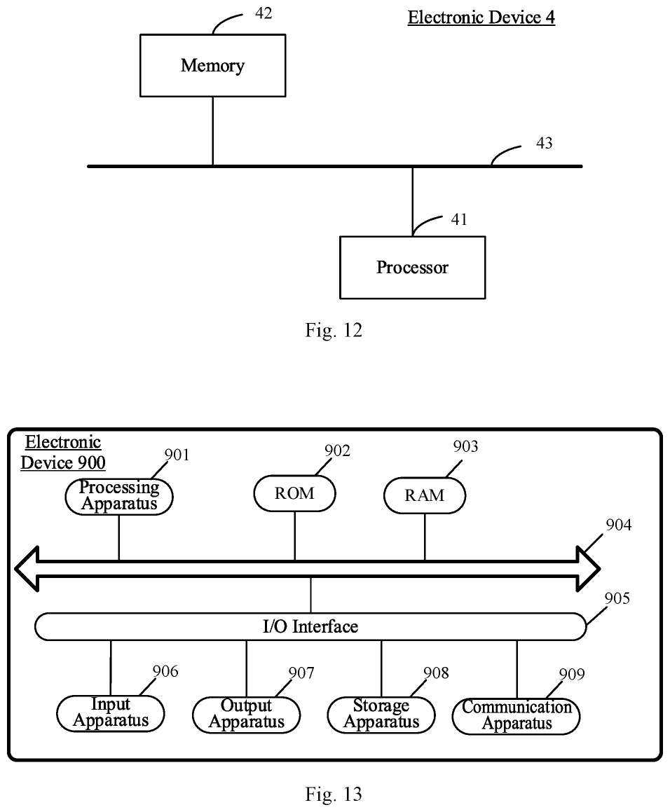

FIG. 12 is a schematic diagram of a structure of an electronic device according to an embodiment of the present disclosure. As shown in FIG. 12, an electronic device 4 includes a processor 41, and a memory 42 in communication connection with the processor 41.

The memory 42 stores computer-executable instructions.

The processor 41 executes the computer-executable instructions stored in the memory 42 to implement the content recognition method according to each of the embodiments shown in FIG. 2 to FIG. 10.

Optionally, the processor 41 and the memory 42 are connected through a bus 43.

The related description may be understood with reference to related description and effects that correspond to the steps in the embodiments corresponding to FIG. 2 to FIG. 10. Details are not described herein again.

An embodiment of the present disclosure provides a computer-readable storage medium. The computer-readable storage medium stores computer-executable instructions, and the computer-executable instructions, when executed by a processor, are used to implement the content recognition method according to any one of the embodiments corresponding to FIG. 2 to FIG. 10 of the present disclosure.

An embodiment of the present disclosure provides a computer program product, including a computer program. When the computer program is executed by a processor, the content recognition method according to any one of the embodiments corresponding to FIG. 2 to FIG. 10 of the present disclosure is implemented.

To implement the above embodiments, an embodiment of the present disclosure further provides an electronic device.

FIG. 13 is a schematic diagram of a structure of an electronic device 900 suitable for implementing the embodiments of the present disclosure. The electronic device 900 may be a terminal device or a server. The terminal device may include, but is not limited to, a mobile terminal such as a mobile phone, a notebook computer, a digital broadcast receiver, a personal digital assistant (PDA), a tablet computer (portable Android device (PAD)), a portable media player (PMP), and a vehicle-mounted terminal (such as a vehicle navigation terminal), and a fixed terminal such as a digital TV and a desktop computer. The electronic device shown in FIG. 13 is merely an example, and shall not impose any limitation on the functions and use scope of the embodiments of the present disclosure.

As shown in FIG. 13, the electronic device 900 may include a processing apparatus 901 (e.g., a central processing unit or a graphics processing unit) that may perform a variety of appropriate actions and processing in accordance with a program stored in a read-only memory (ROM) 902 or a program loaded from a storage apparatus 908 into a random access memory (RAM) 903. The RAM 903 further stores various programs and data required for operations of the electronic device 900. The processing apparatus 901, the ROM 902, and the RAM 903 are connected to each other through a bus 904. An input/output (I/O) interface 905 is also connected to the bus 904.

Generally, the following apparatuses may be connected to the I/O interface 905: an input apparatus 906 including, for example, a touchscreen, a touchpad, a keyboard, a mouse, a camera, a microphone, an accelerometer, and a gyroscope; an output apparatus 907 including, for example, a liquid crystal display (LCD), a speaker, and a vibrator; the storage apparatus 908 including, for example, a tape and a hard disk; and a communication apparatus 909. The communication apparatus 909 may allow the electronic device 900 to perform wireless or wired communication with other devices to exchange data. Although FIG. 13 shows the electronic device 900 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded from a network through the communication apparatus 909 and installed, installed from the storage apparatus 908, or installed from the ROM 902. When the computer program is executed by the processing apparatus 901, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to perform the method shown in the above embodiment.

The computer program code for performing the operations in the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user via any kind of network, including a local area network (LAN) or a wide area network (WAN), or may be connected to an external computer (for example, connected via the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units or modules described in the embodiments of the present disclosure may be implemented by software, or may be implemented by hardware. The name of the unit or module does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, a content recognition method is provided, including:
obtaining a first object category of a main object in an image to be recognized based on the main object, where the first object category is at a first category hierarchy; obtaining a corresponding target category recognition model based on the first object category, and processing the image to be recognized based on the target category recognition model to obtain a second object category and a corresponding prediction confidence, where the second object category is at a second category hierarchy, and the second category hierarchy is a refined hierarchy of the first category hierarchy; and obtaining a first recognition result of the image to be recognized based on the second object category and the corresponding prediction confidence, where the first recognition result represents a predicted object category of the main object, and the predicted object category is between the first category hierarchy and the second category hierarchy.

According to one or more embodiments of the present disclosure, the obtaining the first object category of the main object in the image to be recognized based on the main object includes: acquiring a preset category corresponding to a preset alternative category recognition model; performing object detection on the image to be recognized by using the preset category as a detection parameter, to obtain at least one corresponding target main object belonging to the preset category; and obtaining the corresponding first object category based on the target main object.

According to one or more embodiments of the present disclosure, the obtaining the first recognition result of the image to be recognized based on the second object category and the corresponding prediction confidence includes: in response to the prediction confidence being greater than a confidence threshold, determining the second object category as the first recognition result of the image to be recognized; or in response to the prediction confidence being less than the confidence threshold, determining a generalized object category corresponding to the second object category as the first recognition result of the image to be recognized based on preset label tree data, where at least object categories corresponding to the first category hierarchy and the second category hierarchy are recorded in the label tree data, and the generalized object category is at a generalized hierarchy of the second category hierarchy.

According to one or more embodiments of the present disclosure, the determining the generalized object category corresponding to the second object category as the first recognition result of the image to be recognized based on the preset label tree data includes: determining a target category hierarchy of the label tree data based on the prediction confidence; and acquiring a target generalized object category corresponding to the target category hierarchy, and determining the target generalized object category as the first recognition result of the image to be recognized.

According to one or more embodiments of the present disclosure, the determining the target category hierarchy of the label tree data based on the prediction confidence includes: acquiring a confidence difference and/or a confidence ratio value between the prediction confidence and the confidence threshold; and determining the corresponding target category hierarchy based on the confidence difference and/or the confidence ratio value.

According to one or more embodiments of the present disclosure, the determining the generalized object category corresponding to the second object category as the first recognition result of the image to be recognized based on the preset label tree data includes: acquiring an image access popularity of the image to be recognized; determining a target category hierarchy of the label tree data based on the image access popularity; and acquiring a target generalized object category corresponding to the target category hierarchy, and determining the target generalized object category as the first recognition result of the image to be recognized.

According to one or more embodiments of the present disclosure, after the processing the image to be recognized based on the target category recognition model to obtain the second object category and the corresponding prediction confidence, the method further includes: processing the image to be recognized based on a verification model to obtain a third object category, where the third object category is at a third category hierarchy; and generating a second recognition result in response to the third category hierarchy being not a generalized hierarchy of the second category hierarchy, where the second recognition result represents that the second object category output by the target category recognition model is an incorrect result.

According to one or more embodiments of the present disclosure, after the generating the second recognition result, the method further includes: obtaining a corresponding corrected category recognition model based on the third object category and label tree data; and processing the image to be recognized based on the corrected category recognition model to obtain the second object category and the corresponding prediction confidence.

According to one or more embodiments of the present disclosure, a content recognition apparatus is further provided, including:
a first recognition module configured to obtain a first object category of a main object in an image to be recognized based on the main object, where the first object category is at a first category hierarchy;
a second recognition module configured to obtain a corresponding target category recognition model based on the first object category, and process the image to be recognized based on the target category recognition model to obtain a second object category and a corresponding prediction confidence, where the second object category is at a second category hierarchy, and the second category hierarchy is a refined hierarchy of the first category hierarchy; and
a processing module configured to obtain a first recognition result of the image to be recognized based on the second object category and the corresponding prediction confidence, where the first recognition result represents a predicted object category of the main object, and the predicted object category is between the first category hierarchy and the second category hierarchy.

According to one or more embodiments of the present disclosure, the first recognition module is configured to: acquire a preset category corresponding to a preset alternative category recognition model; perform object detection on the image to be recognized by using the preset category as a detection parameter, to obtain at least one corresponding target main object belonging to the preset category; and obtain the corresponding first object category based on the target main object.

According to one or more embodiments of the present disclosure, the processing module is configured to: in response to the prediction confidence being greater than a confidence threshold, determine the second object category as the first recognition result of the image to be recognized; or in response to the prediction confidence being less than the confidence threshold, determine a generalized object category corresponding to the second object category as the first recognition result of the image to be recognized based on preset label tree data, where at least object categories corresponding to the first category hierarchy and the second category hierarchy are recorded in the label tree data, and the generalized object category is at a generalized hierarchy of the second category hierarchy.

According to one or more embodiments of the present disclosure, when determining the generalized object category corresponding to the second object category as the first recognition result of the image to be recognized based on the preset label tree data, the processing module is configured to: determine a target category hierarchy of the label tree data based on the prediction confidence; and acquire a target generalized object category corresponding to the target category hierarchy, and determine the target generalized object category as the first recognition result of the image to be recognized.

According to one or more embodiments of the present disclosure, when determining the target category hierarchy of the label tree data based on the prediction confidence, the processing module is configured to: acquire a confidence difference and/or a confidence ratio value between the prediction confidence and the confidence threshold; and determine the corresponding target category hierarchy based on the confidence difference and/or the confidence ratio value.

According to one or more embodiments of the present disclosure, when determining the generalized object category corresponding to the second object category as the first recognition result of the image to be recognized based on the preset label tree data, the processing module is configured to: acquire an image access popularity of the image to be recognized; determine a target category hierarchy of the label tree data based on the image access popularity; and acquire a target generalized object category corresponding to the target category hierarchy, and determine the target generalized object category as the first recognition result of the image to be recognized.

According to one or more embodiments of the present disclosure, after processing the image to be recognized based on the target category recognition model to obtain the second object category and the corresponding prediction confidence, the second recognition module is further configured to: process the image to be recognized based on a verification model to obtain a third object category, where the third object category is at a third category hierarchy; and generate a second recognition result in response to the third category hierarchy being not a generalized hierarchy of the second category hierarchy, where the second recognition result represents that the second object category output by the target category recognition model is an incorrect result.

According to one or more embodiments of the present disclosure, after generating the second recognition result, the second recognition module is further configured to: obtain a corresponding corrected category recognition model based on the third object category and label tree data; and process the image to be recognized based on the corrected category recognition model to obtain the second object category and the corresponding prediction confidence.

According to one or more embodiments of the present disclosure, an electronic device is further provided, including at least one processor and a memory.

The memory stores computer-executable instructions.

The at least one processor executes the computer-executable instructions stored in the memory, to cause the at least one processor to perform the content recognition method according to any one of the embodiments of the present disclosure.

According to one or more embodiments of the present disclosure, a computer-readable storage medium is further provided. The computer-readable storage medium stores computer-executable instructions. When a processor executes the computer-executable instructions, the content recognition method according to any one of the embodiments of the present disclosure is implemented.

According to one or more embodiments of the present disclosure, a computer program product including a computer program is further provided. When the computer program is executed by a processor, the content recognition method according to any one of the embodiments of the present disclosure is implemented.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A content recognition method, comprising:
obtaining a first object category of a main object in an image to be recognized based on the main object, wherein the first object category is at a first category hierarchy;
obtaining a corresponding target category recognition model based on the first object category, and processing the image to be recognized based on the target category recognition model to obtain a second object category and a corresponding prediction confidence, wherein the second object category is at a second category hierarchy, and the second category hierarchy is a refined hierarchy of the first category hierarchy; and
obtaining a first recognition result of the image to be recognized based on the second object category and the corresponding prediction confidence, wherein the first recognition result represents a predicted object category of the main object, and the predicted object category is between the first category hierarchy and the second category hierarchy.

2. The method according to claim 1, wherein the obtaining the first object category of the main object in the image to be recognized based on the main object comprises:
acquiring a preset category corresponding to a preset alternative category recognition model;
performing object detection on the image to be recognized by using the preset category as a detection parameter, to obtain at least one corresponding target main object belonging to the preset category; and
obtaining the corresponding first object category based on the target main object.

3. The method according to claim 1, wherein the obtaining the first recognition result of the image to be recognized based on the second object category and the corresponding prediction confidence comprises:
in response to the prediction confidence being greater than a confidence threshold, determining the second object category as the first recognition result of the image to be recognized; or
in response to the prediction confidence being less than the confidence threshold, determining a generalized object category corresponding to the second object category as the first recognition result of the image to be recognized based on preset label tree data, wherein at least object categories corresponding to the first category hierarchy and the second category hierarchy are recorded in the label tree data, and the generalized object category is at a generalized hierarchy of the second category hierarchy.

4. The method according to claim 3, wherein the determining the generalized object category corresponding to the second object category as the first recognition result of the image to be recognized based on the preset label tree data comprises:
determining a target category hierarchy of the label tree data based on the prediction confidence; and
acquiring a target generalized object category corresponding to the target category hierarchy, and determining the target generalized object category as the first recognition result of the image to be recognized.

5. The method according to claim 4, wherein the determining the target category hierarchy of the label tree data based on the prediction confidence comprises:
acquiring a confidence difference and/or a confidence ratio value between the prediction confidence and the confidence threshold; and
determining the corresponding target category hierarchy based on the confidence difference and/or the confidence ratio value.

6. The method according to claim 3, wherein the determining the generalized object category corresponding to the second object category as the first recognition result of the image to be recognized based on the preset label tree data comprises:
acquiring an image access popularity of the image to be recognized;
determining a target category hierarchy of the label tree data based on the image access popularity; and
acquiring a target generalized object category corresponding to the target category hierarchy, and determining the target generalized object category as the first recognition result of the image to be recognized.

7. The method according to claim 1, wherein after the processing the image to be recognized based on the target category recognition model to obtain the second object category and the corresponding prediction confidence, the method further comprises:
processing the image to be recognized based on a verification model to obtain a third object category, wherein the third object category is at a third category hierarchy; and
generating a second recognition result in response to the third category hierarchy being not a generalized hierarchy of the second category hierarchy, wherein the second recognition result represents that the second object category output by the target category recognition model is an incorrect result.

8. The method according to claim 7, wherein after the generating the second recognition result, the method further comprises:
obtaining a corresponding corrected category recognition model based on the third object category and label tree data; and
processing the image to be recognized based on the corrected category recognition model to obtain the second object category and the corresponding prediction confidence.

9. An electronic device, comprising a processor and a memory,
wherein the memory is configured to store computer-executable instructions; and
the processor is configured to execute the computer-executable instructions stored in the memory, to cause the processor to perform a content recognition method, and the content recognition method comprises:
obtaining a first object category of a main object in an image to be recognized based on the main object, wherein the first object category is at a first category hierarchy;
obtaining a corresponding target category recognition model based on the first object category, and processing the image to be recognized based on the target category recognition model to obtain a second object category and a corresponding prediction confidence, wherein the second object category is at a second category hierarchy, and the second category hierarchy is a refined hierarchy of the first category hierarchy; and
obtaining a first recognition result of the image to be recognized based on the second object category and the corresponding prediction confidence, wherein the first recognition result represents a predicted object category of the main object, and the predicted object category is between the first category hierarchy and the second category hierarchy.

10. The electronic device according to claim 9, wherein the obtaining the first object category of the main object in the image to be recognized based on the main object comprises:
acquiring a preset category corresponding to a preset alternative category recognition model;
performing object detection on the image to be recognized by using the preset category as a detection parameter, to obtain at least one corresponding target main object belonging to the preset category; and
obtaining the corresponding first object category based on the target main object.

11. The electronic device according to claim 9, wherein the obtaining the first recognition result of the image to be recognized based on the second object category and the corresponding prediction confidence comprises:
in response to the prediction confidence being greater than a confidence threshold, determining the second object category as the first recognition result of the image to be recognized; or
in response to the prediction confidence being less than the confidence threshold, determining a generalized object category corresponding to the second object category as the first recognition result of the image to be recognized based on preset label tree data, wherein at least object categories corresponding to the first category hierarchy and the second category hierarchy are recorded in the label tree data, and the generalized object category is at a generalized hierarchy of the second category hierarchy.

12. The electronic device according to claim 11, wherein the determining the generalized object category corresponding to the second object category as the first recognition result of the image to be recognized based on the preset label tree data comprises:
determining a target category hierarchy of the label tree data based on the prediction confidence; and
acquiring a target generalized object category corresponding to the target category hierarchy, and determining the target generalized object category as the first recognition result of the image to be recognized.

13. The electronic device according to claim 12, wherein the determining the target category hierarchy of the label tree data based on the prediction confidence comprises:
acquiring a confidence difference and/or a confidence ratio value between the prediction confidence and the confidence threshold; and
determining the corresponding target category hierarchy based on the confidence difference and/or the confidence ratio value.

14. The electronic device according to claim 11, wherein the determining the generalized object category corresponding to the second object category as the first recognition result of the image to be recognized based on the preset label tree data comprises:
acquiring an image access popularity of the image to be recognized;
determining a target category hierarchy of the label tree data based on the image access popularity; and
acquiring a target generalized object category corresponding to the target category hierarchy, and determining the target generalized object category as the first recognition result of the image to be recognized.

15. The electronic device according to claim 9, wherein after the processing the image to be recognized based on the target category recognition model to obtain the second object category and the corresponding prediction confidence, the content recognition method further comprises:
processing the image to be recognized based on a verification model to obtain a third object category, wherein the third object category is at a third category hierarchy; and
generating a second recognition result in response to the third category hierarchy being not a generalized hierarchy of the second category hierarchy, wherein the second recognition result represents that the second object category output by the target category recognition model is an incorrect result.

16. The electronic device according to claim 15, wherein after the generating the second recognition result, the content recognition method further comprises:
obtaining a corresponding corrected category recognition model based on the third object category and label tree data; and
processing the image to be recognized based on the corrected category recognition model to obtain the second object category and the corresponding prediction confidence.

17. A non-transitory computer-readable storage medium, storing computer-executable instructions, wherein when the computer-executable instructions are executed by a processor, a content recognition method is implemented, and the content recognition method comprises:
obtaining a first object category of a main object in an image to be recognized based on the main object, wherein the first object category is at a first category hierarchy;
obtaining a corresponding target category recognition model based on the first object category, and processing the image to be recognized based on the target category recognition model to obtain a second object category and a corresponding prediction confidence, wherein the second object category is at a second category hierarchy, and the second category hierarchy is a refined hierarchy of the first category hierarchy; and
obtaining a first recognition result of the image to be recognized based on the second object category and the corresponding prediction confidence, wherein the first recognition result represents a predicted object category of the main object, and the predicted object category is between the first category hierarchy and the second category hierarchy.

18. The non-transitory computer-readable storage medium according to claim 17, wherein the obtaining the first object category of the main object in the image to be recognized based on the main object comprises:
acquiring a preset category corresponding to a preset alternative category recognition model;
performing object detection on the image to be recognized by using the preset category as a detection parameter, to obtain at least one corresponding target main object belonging to the preset category; and
obtaining the corresponding first object category based on the target main object.

19. The non-transitory computer-readable storage medium according to claim 17, wherein the obtaining the first recognition result of the image to be recognized based on the second object category and the corresponding prediction confidence comprises:
in response to the prediction confidence being greater than a confidence threshold, determining the second object category as the first recognition result of the image to be recognized; or
in response to the prediction confidence being less than the confidence threshold, determining a generalized object category corresponding to the second object category as the first recognition result of the image to be recognized based on preset label tree data, wherein at least object categories corresponding to the first category hierarchy and the second category hierarchy are recorded in the label tree data, and the generalized object category is at a generalized hierarchy of the second category hierarchy.

20. The non-transitory computer-readable storage medium according to claim 19, wherein the determining the generalized object category corresponding to the second object category as the first recognition result of the image to be recognized based on the preset label tree data comprises:
determining a target category hierarchy of the label tree data based on the prediction confidence; and
acquiring a target generalized object category corresponding to the target category hierarchy, and determining the target generalized object category as the first recognition result of the image to be recognized.
